(19) United States
(12) Patent Application Publication
(10) Pub. No.: US 2024/0200678 A1
(43) Pub. Date: Jun. 20, 2024

(54) VALVE FOR GAS CYLINDER WITH CHECK-VALVE PREVENTING UNOFFICIAL REFILLING

(71) Applicant: ROTAREX S.A., Lintgen (LU)

(72) Inventors: Ingo Weinert, Kirchhain (DE); Jean-Claude Schmitz, Heisdorf (DE)

(21) Appl. No.: 18/308,945

(22) Filed: Apr. 28, 2023

(30) Foreign Application Priority Data
Dec. 16, 2022 (LU) LU503200

(51) Int. Cl. F16K 21/04; F16K 15/04; F17C 13/04

(52) U.S. Cl. CPC F16K 21/04; F16K 15/044; F17C 13/04; F17C 2205/0332; F17C 2205/0335

(57) ABSTRACT

A valve for a gas tank, comprising a body comprising an engaging portion for sealingly engaging with a gas tank, a gas inlet, a gas outlet, and a gas passage fluidly connecting the gas inlet and the gas outlet; a shut-off device in the gas passage; a check-valve comprising a check-valve seat in the gas passage; a check-valve obturator configured for contacting the check-valve seat and thereby closing the gas passage in the presence of a refill gas flow from the gas outlet to the gas inlet; wherein the check-valve seat is resiliently urged against the body and configured to move away from the body so as to open the gas passage when subjected to a refill differential pressure reaching a predetermined threshold.

### CROSS-REFERENCE TO RELATED APPLICATIONS

This application claims the benefit, under 35 U.S.C. § 119, of LU503200 filed on Dec. 16, 2022, the disclosure of which is incorporated herein by reference in its entirety.

### FIELD

The invention is directed to the field of valves for gas cylinder, more particular for gas cylinders subject to regular refilling like gas cylinder containing fuel gases like butane and propane.

### BACKGROUND

The patent document published WO 2015/044355 A1 discloses a valve for a compressed gas cylinder, comprising: a valve body with an inlet, an outlet and a passage connecting the inlet with the outlet; a shut-off device of the passage with an actuating pin extending in the passage; a check-valve between the shut-off device and the inlet, the check valve comprising a seat and a movable closing member initially held at a position distant from the seat by contact with a guiding surface and movable past the position by the pin so as to cooperate with the seat and prevent a refilling flow of gas from the outlet to the inlet. The guiding surface is on a tubular portion fixed to the valve body and comprising at least one radial aperture so as to allow the refilling flow of gas to by-pass the closing member when in the distant position.

Prior art patent document published U.S. Pat. No. 3,704,813 discloses a gas valve for compressed gas cylinders that prevents refilling. FIG. 2 of this document discloses a cylinder valve with a shut-off device, a pressure relief device and a check valve preventing refilling of the cylinder. The shut-off and pressure relief devices are combined and open when a refilling flow of gas is applied. The check valve comprises a ball held at a position distant from its seat by means of spring finger detents. The combined shut-off and pressure relief devices comprise a pin extending out of the valve body for actuating the shut-off device. Upon an opening stroke beyond a predetermined limit, the movable closing member of the shut-off device contacts the ball and pushes it beyond its holding position distant from the seat. The ball is then freed and can cooperate with its seat to prevent refilling of the cylinder after the first use of the gas. FIG. 3 of this document discloses an alternative design where the pressure relief device is separate from the shut-off device, the principle of the check valve operated by the first opening of the shut-off device remaining the same. In both designs, the spring finger detents restrict the available cross area for the check valve spring. Additionally, under certain circumstances the assembling operations of the check valve might be rendered difficult in that the ball might tend to escape from its seat on the finger detents. Also, both designs require much space laterally.

The anti-refilling valves of the above prior art show as disadvantage they do not allow refilling of the gas cylinder even by an authorized gas provider.

### SUMMARY

The invention has for objective to overcome at least one drawback of the prior art, more particularly to provide a gas cylinder valve preventing refilling by end consumer while allowing refilling by authorized gas providers.

The invention is directed to a valve for a gas tank, comprising a body comprising an engaging portion for sealingly engaging with a gas tank, a gas inlet, a gas outlet, and a gas passage fluidly connecting the gas inlet and the gas outlet; a shut-off device in the gas passage; a check-valve comprising a check-valve seat in the gas passage; a check-valve obturator configured for contacting the check-valve seat and thereby closing the gas passage in the presence of a refill gas flow from the gas outlet to the gas inlet; wherein the check-valve seat is resiliently urged against the body and configured to move away from the body so as to open the gas passage when subjected to a refill differential pressure reaching a predetermined threshold.

According to an exemplary embodiment, the gas passage extends longitudinally in the body, the check-valve seat being configured for opening the passage in a radial direction.

According to an exemplary embodiment, the check-valve seat is movable longitudinally.

According to an exemplary embodiment, the check-valve seat comprises a cylindrical sleeve slidingly received in a housing attached to the body.

According to an exemplary embodiment, the check-valve comprises a spring located in the housing and resiliently urging the check-valve seat against the body.

According to an exemplary embodiment, the housing comprises a cylindrical wall with radial passages for the refill gas flow.

According to an exemplary embodiment, the radial passages are closed by the cylindrical sleeve when the check-valve seat is against the body and are opened when the check-valve seat is moved away from the body.

According to an exemplary embodiment, the cylindrical wall of the housing comprises a thread engaging with a corresponding thread on the body.

According to an exemplary embodiment, the check-valve seat comprises a hole forming the gas passage through the check-valve seat, to be closed by the check-valve obturator.

According to an exemplary embodiment, the check-valve seat comprises a gasket contacting in a gas tight fashion an inner surface of the body, when the check-valve seat is resiliently urged against the body, the gasket being away from the inner surface of the body when the check-valve body is moved away from the body.

According to an exemplary embodiment, the check-valve seat comprises an outer surface with longitudinal recesses extending from the gasket towards the shut-off device.

According to an exemplary embodiment, the valve further comprises an excess flow valve seat in the gas passage, opposed to the check-valve seat and configured for being contacted by the check-valve obturator so as to close or reduce the gas passage in the presence of a service gas flow from the gas inlet to the gas outlet that reaches a predetermined excess flow.

According to an exemplary embodiment, the excess flow valve seat is formed by a circular hollow and stepped element inserted into a bore of the body on the gas inlet side.

According to an exemplary embodiment, the circular hollow and stepped element comprises at a proximal end thereof an inner surface slidingly receiving a pin of an obturator of the shut-off device, the proximal end supporting a spring urging the shut-off device obturator towards a seat of the shut-off device.

According to an exemplary embodiment, the circular hollow and stepped element comprises a distal end adjacent a ring housed in an inner groove in the bore of the body and holding the circular hollow and stepped element in the bore.

According to an exemplary embodiment, the predetermined threshold is comprised between 8 and 17 bar.

The above invention is advantageous in that it provides a simple and reliable solution for preventing unauthorized or unofficial refilling of a gas tank e.g., refilling by merely fluidly connecting a filled gas tank to an emptied gas tank. The check-valve obturator can also form an overflow or excess flow valve. The pressure differential necessary for opening the check-valve can be easily adjusted by selecting an appropriate check-valve spring. The flow of the gas during authorized refilling i.e., through the radial passages, is optimized by diffusing the flow radially around the housing adjacent the check-valve.

### DRAWINGS

FIG. 1 is a longitudinal sectional view of a valve for gas cylinder, according to the invention, in a closed state.

FIG. 2 is a transversal sectional view II-II of the valve of FIG. 1.

FIG. 3 corresponds to FIG. 1, where the valve is in an opened state e.g., during normal use.

FIG. 4 corresponds to FIGS. 1 and 2, where the excess flow valve is in a closed state due to gas overflow.

FIG. 5 corresponds to FIGS. 1 to 3, where the check-valve is in a closed state due to an unauthorized refill attempt.

FIG. 6 corresponds to FIGS. 1 to 4, where the check-valve is in an opened state due to an authorized refill action.

### DETAILED DESCRIPTION

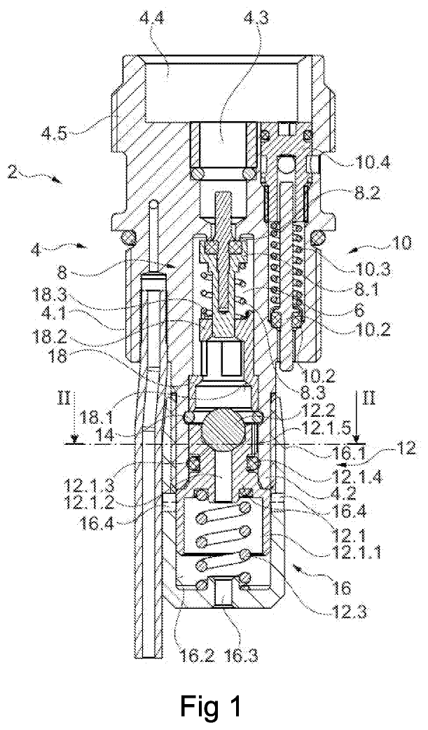

FIG. 1 is a longitudinal sectional view of a valve for a gas tank, for instance a gas cylinder, according to the invention.

The valve 2 comprises a body 4, being for instance made of single piece and being understood that it can be made of several parts assembled together. The body 4 comprises an engaging portion 4.1 that is designed for engaging with the neck of a gas cylinder. For instance, that engaging portion 4.1 comprises an outer thread, a gasket housed in a circular outer groove and a shoulder directly adjacent to the circular outer groove, so that upon engagement by rotation of the outer thread with an inner thread of the neck of the gas cylinder, the gasket gets closer and eventually contacts an inner surface at the distal edge of the neck of the gas cylinder and the shoulder abuts against an upper outer surface of the distal edge. It is however understood that other engaging portions can be considered, for example a flange with a gasket for mounting on an essentially flat wall of a gas tank.

The body 4 comprises a gas inlet 4.2 intended to be inside the gas tank, and a gas outlet 4.3 intended to be outside the gas tank, once the valve 2 is mounted on the gas tank. The body 4 comprises a gas passage 6 fluidly interconnecting the gas inlet 4.2 and the gas outlet 4.3.

The valve 4 comprises a shut-off device 8 comprising a shut-off device obturator 8.1, a shut-off device seat 8.2 located in and surrounding the gas passage 6, and a spring 8.3 urging the shut-off device obturator 8.1 towards the shut-off device seat 8.2 so as to normally close the gas passage 6. As this is apparent, the shut-off device obturator 8.1 is located on an upstream side of the shut-off device seat 8.2 (relative to a normal gas flow direction from the gas inlet to the gas outlet), meaning that the pressure of the gas at the gas inlet 4.2 urges the shut-off device obturator 8.1 towards the shut-off device seat 8.2. The shut-off device obturator 8.1 comprises an actuating pin extending through the shut-off device seat 8.2 towards the gas outlet 4.3, allowing to open the shut-off device by pressing on the actuating pin on the gas outlet 4.3 side.

The valve 2 further comprises a pressure relief valve 10 comprising a pressure relief obturator 10.1, a pressure relief seat 10.2 and a pressure relief spring 10.3 urging the pressure relief obturator 10.1 against the pressure relief seat 10.2 in order to close a pressure relief gas passage in the body 4, from inside the gas tank to outside the gas tank. For instance, that pressure relief gas passage is distinct and parallel to the gas passage 6 whereas in other possible configurations it could be branched to the gas passage 6. The pressure relief seat 10.2 is for instance formed directly in the body around the pressure relief gas passage. The pressure relief obturator 10.1 is located on a downstream side of the pressure relief seat 10.2, so that while being normally urged by the pressure relief spring 10.3 against the pressure relief seat 10.2, it is moved away from the pressure relief seat 10.2 when the pressure inside the gas tank reaches a predetermined level that it sufficient to counteract the force of the pressure relief spring 10.3. As this is apparent, the pressure relief valve 10 can comprise a closing and guiding element 10.4 engaged with the body 4 on an outlet side of the valve 2. That closing and guiding element 10.4 comprises a bore receiving an end portion of a stem of the pressure relief obturator 10.1 for guiding the stem. It further comprises a front face around an opening of the bore, receiving an end of the pressure relief spring 10.3. It can further comprise a radial hole fluidly interconnecting the bore with an annular space formed between the closing and guiding element 10.4 and the body 4. The closing and guiding element 10.4 comprises for instance an annular groove on its outer surface, being however understood that other similar and/or equivalents constructions can be considered. The annular space can fluidly communicate with the ambient through radial hole formed in the body. The closing and guiding element 10.4 advantageously forms with the body 4 a gas tight barrier, for instance by virtue of the gasket housed in a groove on distal part of the outer surface of the element, being however understood that other sealing means can be considered.

The valve 2 further comprises a check-valve 12 which is for instance located upstream of the shut-off device 8 i.e., between the shut-off device 8 and the gas inlet 4.2. The check-valve 12 comprises a check-valve seat 12.1 and a check-valve obturator 12.2 cooperating with the check-valve seat 12.1. The check-valve 12, in the present case, does not comprise a spring for urging the check-valve obturator 12.2 towards the check-valve 12.1, the check-valve obturator 12.2 being naturally urged toward the check-valve seat 12.1 by gravity and also by the flow dynamics in the presence of a refill gas flow from the gas outlet 4.3 to the gas inlet 4.2. It is however understood that a spring could be provided. The check-valve seat 12.1 comprises a cylindrical sleeve 12.1.1 slidingly received in a housing 16 attached to body 4, thereby forming a piston. The check-valve seat 12.1 comprises a hole 12.1.2 forming the gas passage 6 between the gas inlet 4.2 and the gas outlet 4.3. The check-valve seat 12.1 comprises a contact surface 12.1.3 surrounding the hole 12.1.2 and intended to be contacted by the check-valve obturator 12.2 for closing the gas passage 6 in the presence of a refill gas flow. The check-valve seat 12.1 further comprises a gasket 12.1.4 housed in an annular groove formed an outer surface thereof and contacting in a gas tight fashion a corresponding inner surface of the gas inlet 4.2 on the body 4, being for instance sleeve-shaped. As this is apparent, the portion of the check-valve seat 12.1 through which the hole 12.1.2 is formed forms with the cylindrical sleeve a circular shoulder that is urged against the distal end of the gas inlet 4.2 on the body 4 by the check-valve spring 12.3. In that position that can be considered as a closed position of the check-valve seat 12.1, the gasket 12.1.4 is in the above gas tight contact with the inner surface of the gas inlet 4.2 on the body 4.

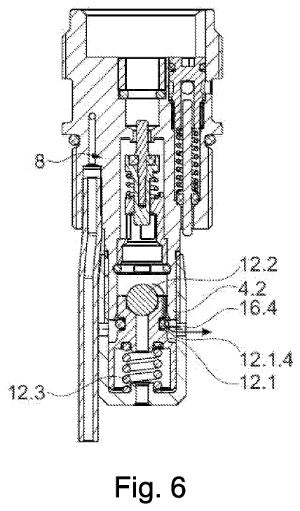

The check-valve seat 12.1 can comprise on the outer surface of its portion through which the hole 12.1.2 is formed, longitudinal recesses or grooves 12.1.5 allowing the gas to flow in the gas refill direction when the check-valve seat 12.1 is moved by the refill pressure against the force of the check valve spring 12.3. In that position, shown in FIG. 6 and further detailed below in connection with that figure, the gasket 12.1.4 does not contact that inner surface of the gas inlet 4.2 on the body 4 anymore and open a gas refill passage. This means that a refill differential pressure on the check-valve seat 12.1 needs to reach a predetermined threshold for opening the above-mentioned gas refill passage. That predetermined threshold can be set to a level that requires a pump for properly refilling gas. The predetermined threshold can be comprised between 8 and 17 bar. An unauthorized refilling by connecting a filled gas tank to an emptied gas tank cannot therefore take place.

The housing 16 generally forms a cylindrical cap with a distal portion 16.1 engaging with the gas inlet 4.2 on the body 4, for instance with an inner thread engaging with an outer thread on the gas inlet 4.2 on the body 4, being however understood that other engagement means can be considered. The threaded engagement between the housing 16 and the body 4 allows the check-valve 12 to be adjusted by changing the preconstraint of the check-valve spring 12.3 in varying the longitudinal relative position of the housing 16 relative to the body 4. Once a final position is reached, it can be fixed by plastically localling deforming the distal portion 16.1 of housing 16 and optionally also the corresponding portion of the body 4. It is however understood that other fixing means can be considered like thread locker or the like. The housing 16 further comprises an inner cylindrical surface 16.2 slidingly receiving the cylindrical sleeve 12.1.1 of the check-valve seat 12.1. The housing 16 further comprises at a bottom thereof a hole 16.3 forming the gas passage 6 interconnecting the gas inlet 4.2 with the gas outlet 4.3. The housing 16 can still further comprise at least one or several radial holes 16.4 formed in the cylindrical wall thereof adjacent the front face of the gas inlet 4.2 on the body 4, in order to allow the refill gas to flow radially towards the tank during refilling and when the check-valve seat 12.1 is moved away from the gas inlet 4.2 on the body 4 so as to open a refill gas passage.

The valve 2 can further comprise an element 18 that is advantageously circular hollow and stepped element and located in the gas passage 6 in the body 4, between the check-valve 12 and the shut-off device 8. That element 18 can form an excess flow valve seat 18.1 designed for cooperate with the check-valve obturator 12.2 being for instance a ball. It is understood that various shapes of check-valve obturators, other than a ball, can be considered. As this is apparent, the excess flow valve seat 18.1 is generally conical or at least shows a profile that converges towards the shut-off valve 8. The element 18 comprises at a proximal end 18.3 thereof an inner guiding surface 18.2 slidingly receiving a pin of the shut-off device obturator 8.1, the proximal end 18.3 supporting the shut-off device spring 8.3 urging the shut-off device obturator 8.1 towards the shut-off device seat 8.2. When the shut-off device is opened, the pin of the shut-off device obturator 8.1 is moved down passed the inner guiding surface 18.2 such as to keep the shut-off device obturator 8.1 off the excess flow valve seat 18.1, thereby deactivating the excess flow valve function. The element 18 comprises openings, for instance 3 openings, in the proximal end 18.3, providing a portion of the gas passage 6, between the excess flow valve seat 18.1 and the shut-off device 8. The element 18 is advantageously inserted into a bore made in the body 4. It is for instance held in position by a ring 14 which can be an open elastic ring.

Back to the general layout of the valve 2, the body 4 at the outlet 4.3 can be provided with a bore 4.4 for receiving a corresponding portion of a gas reducer or regulator (not illustrated). The body 4 can also comprise engaging means being for instance an outer thread 4.5, for engaging with the above-mentioned gas reducer or regulator. The latter can comprise a central pin that contacts the distal end of the pin of the shut-off device obturator 8.1, once engaged with the valve 2.

As also visible in FIG. 1, the valve 2 can comprise a dip tube extending longitudinally distally into the gas tank or cylinder onto which the valve is to be mounted. The purpose of this dip tube is to provide a means for limiting the level of gas in liquid phase during filling. A small vent screw is engaged on the body at an outlet of the dip tube and can be slightly opened during filling; once the liquid phase reaches the inlet or distal end of the dip tube, a vapor flow appears at the slightly pended vent screw, providing a visible signal that the liquid phase has reached the dip tube.

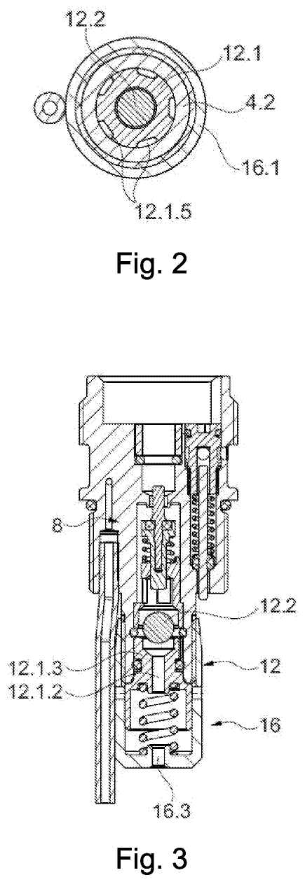

FIG. 2 is a transversal sectional view II-II of the valve in FIG. 1. The portion of the check-valve seat 12.1 that comprises the surface receiving the check-valve obturator 12.2 is well visible. We can see that the longitudinal recesses or grooves 12.1.5 allowing the gas to flow in the gas refill direction when the check-valve seat 12.1 is moved open by the refill pressure. The longitudinal recesses or grooves 12.1.5 are for instance five thereof and distributed homogeneously around the check-valve seat 12.1, being however understood that other configurations can be considered, however not necessarily providing the same advantages as those provided by the arrangement as in FIG. 2.

FIG. 3 illustrates the valve of FIGS. 1 and 2, being a longitudinal sectional view similarly to FIG. 1, the valve being however in an opened and normally operating state.

As this is apparent, the shut-off device 8 is opened and the check-valve 12 is opened. The check-valve obturator 12.2 being off the contact surface 12.1.3 of the check-valve and thereby allow gas from the gas tank (not represented) to flow through the orifice 16.3 in the housing 16 and through the passage 12.1.2 in the check-valve seat 12.1, along the check-valve obturator 12.2, towards the opened shut-off device 8.

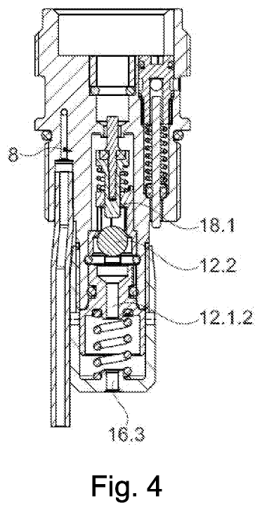

FIG. 4 illustrates the valve of FIGS. 1, 2 and 3, being a longitudinal sectional view similarly to FIGS. 1 and 3, the excess flow valve being however in a closed state due to an overflow of gas.

As this is apparent, the check-valve obturator 12.2 contacts the excess flow seat 18.1, further to an increase of the gas flow in the valve configuration of FIG. 3, to such a point that the pressure differential exerted on the check-valve obturator 12.2 reaches the gravity forces and therefore moves its towards the excess flow seat 18.1.

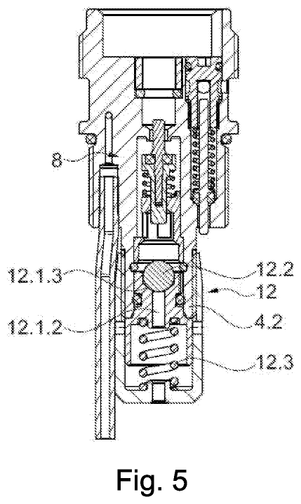

FIG. 5 illustrates the valve of FIGS. 1, 2, 3 and 4, being a longitudinal sectional view similarly to FIGS. 1, 3 and 4, the check-valve being however in a closed state due to an unauthorized refill attempt.

As this is apparent, the shut-off device 8 is opened, allowing refill gas to flow from to the gas outlet towards the gas tank (not represented). The check-valve 12 is however in a closed state due to the check-valve obturator 12.2 contacting the check-valve seat 12.1. The refill gas cannot flow through the hole 12.1.2 and is therefore blocked. No gas refill can take place under such conditions. In that state, the check-valve seat 12.1 is in abutment against the gas inlet 4.2 on the body 4, by virtue of the check-valve spring 12.3.

FIG. 6 illustrates the valve of FIG. 5, the valve being however in an opened state allowing an authorized refilling of the gas tank (not represented).

Compared with the state of the valve in FIG. 5, the refill pressure is increased, leading to the resulting force on the check-valve seat 12.1 exerted by the gas to supersede the resilient force of the check-valve spring 12.3, thereby moving the check-valve seat 12.1 away from the body 4 up to a point where the gasket 12.1.4 leaving the inner surface of the gas inlet 4.2 of the body 4 and opening a gas refill passage through the radial holes 16.4 formed in the housing 16.

What is claimed is:

1. A valve for a gas tank, said valve comprising:
a body comprising:
an engaging portion for sealingly engaging with a gas tank,
a gas inlet,
a gas outlet, and
a gas passage fluidly connecting the gas inlet and the gas outlet;
a shut-off device in the gas passage;
a check-valve comprising:
a check-valve seat in the gas passage;
a check-valve obturator configured for contacting the check-valve seat and thereby closing the gas passage in the presence of a refill gas flow from the gas outlet to the gas inlet;
wherein the check-valve seat is resiliently urged against the body and configured to move away from the body so as to open the gas passage when subjected to a refill differential pressure reaching a predetermined threshold.

2. The valve according to claim 1, wherein the gas passage extends longitudinally in the body, the check-valve seat being configured for opening the gas passage in a radial direction.

3. The valve according to claim 2, wherein the check-valve seat is movable longitudinally.

4. The valve according to claim 3, wherein the check-valve seat comprises a cylindrical sleeve slidingly received in a housing attached to the body.

5. The valve according to claim 4, wherein the check-valve comprises a spring located in the housing and resiliently urging the check-valve seat against the body.

6. The valve according to claim 4, wherein the housing comprises a cylindrical wall with radial passages for the refill gas flow.

7. The valve according to claim 6, wherein the radial passages are closed by the cylindrical sleeve when the check-valve seat is against the body and are opened when the check-valve seat is moved away from the body.

8. The valve according to claim 6, wherein the cylindrical wall of the housing comprises a thread engaging with a corresponding thread on the body.

9. The valve according to claim 1, wherein the check-valve seat comprises a hole forming the gas passage through the check-valve seat, to be closed by the check-valve obturator.

10. The valve according to claim 1, wherein the check-valve seat comprises a gasket contacting in a gas tight fashion an inner surface of the body, when the check-valve seat is resiliently urged against the body, the gasket being away from the inner surface of the body when the check-valve seat is moved away from the body.

11. The valve according to claim 10, wherein the check-valve seat comprises an outer surface with longitudinal recesses extending from the gasket towards the shut-off device.

12. The valve according to claim 1, further comprising:
an excess flow valve seat in the gas passage, opposed to the check-valve seat and configured for being contacted by the check-valve obturator so as to close or reduce the gas passage in the presence of a service gas flow from the gas inlet to the gas outlet that reaches a predetermined excess flow.

13. The valve according to claim 12, wherein the excess flow valve seat is formed by a circular hollow and stepped element inserted into a bore of the body on the gas inlet side.

14. The valve according to claim 13, wherein the circular hollow and stepped element comprises at a proximal end thereof an inner surface slidingly receiving a pin of an obturator of the shut-off device, the proximal end supporting a spring urging the shut-off device obturator towards a seat of the shut-off device.

15. The valve according to claim 13, wherein the circular hollow and stepped element comprises a distal end adjacent a ring housed in an inner groove in the bore of the body and holding the circular hollow and stepped element in the bore.

16. The valve of claim 1, wherein the predetermined threshold is comprised between 8 and 17 bar.
